(19) United States
(12) Patent Application Publication
(10) Pub. No.: US 2008/0270436 A1
(43) Pub. Date: Oct. 30, 2008

(54) Storing chunks within a file system

(76) Inventors: Samuel A. Fineberg, Palo Alto, CA (US); Arthur Britto, Berkeley, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/796,674

(22) Filed: Apr. 27, 2007

(51) Int. Cl. G06F 17/30

(52) U.S. Cl. 707/101; 707/E17.005

(57) ABSTRACT

A method, apparatus, and system are disclosed for storing chunks within a file system. In one embodiment, the chunks are stored in a file system of a client computer and used to reconstruct the file.

### BACKGROUND

Storage and management of electronic data have become increasingly important for both individuals and organizations. Increasing processor speeds, memory capacities, mass-storage-device capacities, and networking bandwidths have provided an expanding platform for complex computer applications that generate large amounts of electronic data that need to be reliably and efficiently stored.

Copying data to a storage location or retrieving data from a storage location is not only time consuming but also costly. The cost and time to transfer or retrieve data depends in part on the amount of bandwidth being used. As the bandwidth usage increases, the cost and time to retrieve and send data also increases. Computing and storage systems can reduce time and other costs associated with bandwidth usage if data is retrieved and sent to storage using efficient techniques.

### BRIEF DESCRIPTION OF THE DRAWINGS

FIG. 1 illustrates an exemplary system for storing and retrieving files in accordance with an embodiment of the present invention.

FIG. 2A illustrates an exemplary flow diagram for generating and storing chunks in a client file system in accordance with an embodiment of the present invention.

FIG. 2B illustrates an exemplary architecture for FIG. 2A in accordance with an embodiment of the present invention.

FIG. 3A illustrates an exemplary flow diagram for retrieving a file in accordance with an embodiment of the present invention.

FIG. 3B illustrates an exemplary architecture for FIG. 3A in accordance with an embodiment of the present invention.

FIG. 4A illustrates an exemplary flow diagram for storing a file in accordance with an embodiment of the present invention.

FIG. 4B illustrates an exemplary architecture for FIG. 4A in accordance with an embodiment of the present invention.

### DETAILED DESCRIPTION

Exemplary embodiments in accordance with the present invention are directed to systems, methods, and apparatus for efficiently storing, retrieving, and reconstructing files and data in a client-server storage system. In one embodiment, client-side files are stored, and chunks of these files are logically created. An index is built to map the chunks to a storage location. The method indexes and points to file blocks rather than creating an independent chunk cache in the file system. By utilizing existing file blocks stored in the client file system, exemplary embodiments utilize less space than a traditional cache system and operate more efficiently. In the client file system, chunks or blocks are stored that are likely to be re-used, for example in a file update. The amount of bandwidth used to retrieve files from and send files to remote storage is reduced.

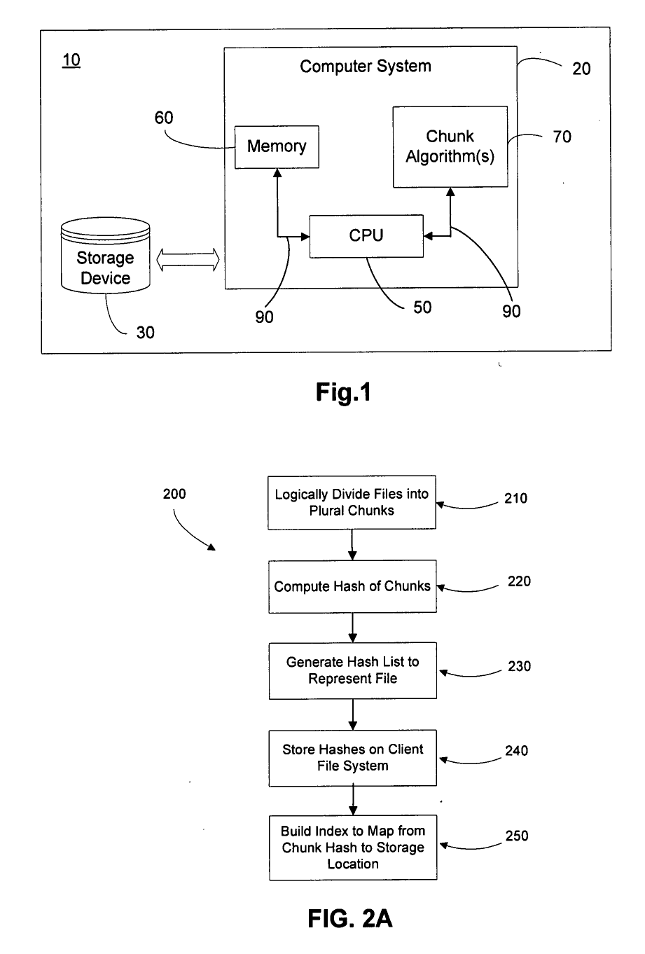

Exemplary embodiments are utilized with various systems and apparatus. FIG. 1 illustrates an exemplary system 10 for storing, retrieving, and reconstructing files in accordance with an embodiment of the present invention.

The system 10 includes a computer system 20 and remote storage device 30. The computer system 20 comprises a processing unit 50 (such as one or more processors of central processing units, CPUs) for controlling the overall operation of memory 60 (such as random access memory (RAM) for temporary data storage and read only memory (ROM) for permanent data storage) and one or more chunk algorithms 70. The memory 60, for example, stores data, control programs, file system, and other data associated with the computer system 20. In some embodiments, the memory 60 stores algorithm 70, chunk hashes, client chunk indexes, and other information and data. The processing unit 50 communicates with memory 60, storage device 30, algorithm 70, and many other components via buses 90.

Embodiments in accordance with the present invention are not limited to any particular type or number of computer systems. The computer system, for example, includes various portable and non-portable computers and/or electronic devices. Exemplary computer systems include, but are not limited to, computers (portable and non-portable), servers, main frame computers, distributed computing devices, laptops, and other electronic devices and systems whether such devices and systems are portable or non-portable.

Embodiments in accordance with the present invention are not limited to any particular type or number of storage devices. By way of example, storage device 30 includes one or more of a warehouse, data base, and/or network attached storage devices providing random access memory (RAM) and/or disk space (for storage and as virtual RAM) and/or some other form of storage such as storage arrays, disk arrays, magnetic memory (example, tapes), micromechanical systems (MEMS), or optical disks, to name a few examples.

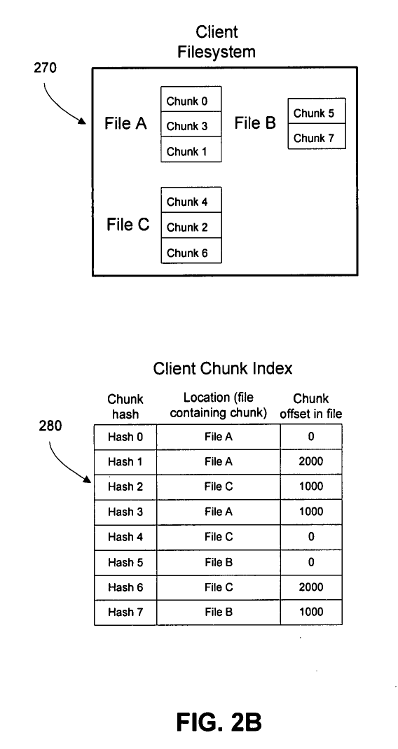

Reference is now made to FIGS. 2-4 wherein exemplary embodiments in accordance with the present invention are discussed in more detail. In order to facilitate a more detailed discussion of exemplary embodiments, certain terms and nomenclature are explained.

As used herein, the term “chunking” means dividing or separating, with a computing device, a file into plural smaller units, segments, or chunks. A chunk can be a fixed or variable length set of bytes, and chunked file can be reconstructed by concatenating or linking file chunks in the correct order.

As used herein, the term “file” has broad application and includes documents (example, files produced or edited from a software application), collection of related data, and/or sequence of related information (such as a sequence of electronic bits) stored in a computer. In one exemplary embodiment, files are created with software applications and include a particular file format (i.e., way information is encoded for storage) and a file name. Embodiments in accordance with the present invention include numerous different types of files such as, but not limited to, text files (a file that holds text or graphics, such as ASCII files: American Standard Code for Information Interchange; HTML files: Hyper Text Markup Language; PDF files: Portable Document Format; office productivity document formal files; and Postscript files), program files, and/or directory files.

As used herein, the term “file system” means a method or system for storing and organizing computer files and data contained in the files. A file system uses one or more abstract data types to store, organize, manipulate, navigate, access, transmit, and/or retrieve files and data.

As used herein, the term “storage device” means any data storage device capable of storing data including, but not limited to, one or more of a disk array, a disk drive, a tape drive or virtual tape drive, optical drive, a SCSI device, a fiber channel device, a network file server, an archival storage server, or other devices noted herein. As used herein, a “disk array” or “array” is a storage system that includes plural disk drive, a cache, and controller. Arrays include, but are not limited to, networked attached storage (NAS) arrays, modular SAN arrays, monolithic SAN arrays, utility SAN arrays, and storage virtualization.

FIG. 2A illustrates an exemplary flow diagram 200 for generating and storing chunks in a client file system in accordance with an embodiment of the present invention. In one exemplary embodiment, the flow diagram is used with a client file system to generate chunks from files and efficiently manage and store the chunks to eliminate and/or reduce duplicative or unnecessary bandwidth usage to a remote storage device.

According to block 210, each file is logically divided or separated into plural portions, units, segments, or chunks. The files, for example, are retrieved or provided from one or more storage locations.

Various methods can be used to divide a file into chunks. For example, content-based variable-length chunking is one exemplary method of breaking a file into a sequence of chunks or segments. Local content of the file determines the boundaries (or breakpoints) for the plural chunks in a file. Chunks or segments of a file have different or non-fixed sizes. As another example, chunks can have fixed sizes. For example, the distance from the beginning of a file determines the chunk boundaries.

According to block 220, a hash for each chunk is computed. A hash value, for example, is a number generated from a string of text or data. The hash is generally smaller than the text itself and is generated by a formula. A hash function H, for example, is a transformation that takes an input “m” and returns a fixed-size string, called a hash value “h” (such that h=H(m)). The hash value concisely represents the chunk (i.e., the longer portion of the file or segment from which the hash was computed). This value is also called the message digest.

The hash value is shorter than the typical size of the chunk and fixed in length or size. As such, hashes are computationally quicker to compare than chunks. Further, hashes enable efficient lookup and comparison (example, using reverse indices and lookup tables). In one exemplary embodiment, for a given pair of chunks, they are either a perfect match (i.e., having the same hash code) or their hash codes differ. Further, two files can be similar and share one or more hash codes. For example, file A can be different than file B yet still share one or more chunks with file.

One exemplary embodiment computes a cryptographic hash for each chunk. In a cryptographic hash, the hash value is computationally simple to calculate for an input, but it is difficult to find two inputs that have the same value or to find an input that has a particular hash value. Further, in one exemplary embodiment, the hash function is collision-resistant. The bit-length of the hash code is sufficiently long to avoid having many accidental hash collisions among truly different chunks.

A variety of hash functions (now known or developed in the future) can be utilized with embodiments in accordance with the present invention. Examples of such hash functions include, but are not limited to, MD5, SHA-1/SHA-2 (Secure Hash Algorithm), digital signatures, and other known or hereafter developed hashing algorithms.

According to block 230, a hash list is generated to represent a file. Each chunked file or object is represented with a hash list. The hash list is an ordered list of the hashes of the chunks that form the file or object. By way of example, exemplary embodiments refer to the chunk C using hash(C). If file A is a one megabyte file, then file A can be divided into ten chunks, each chunk having about one hundred kilobytes. Thus, file A=C1 (chunk 1)+C2 (chunk 2)+ . . . C10 (chunk 10). If file 1A=C1, C3, . . . C10, then hash_list(file A)=hash(C1), hash(C2), hash, (C3), . . . hash(C10).

According to block 240, the chunks and hash list are stored on the file system of the client computer. In another embodiment, the chunks and hash list are already stored in memory. The hash lists, however, do not need to be stored in the file system. By way of example, they can be stored in the remote storage system, memory, or not at all. On the client system, a mapping exists from chunk hash to chunk location (the hash index).

According to block 250, an index is built to map from the chunk hash to the storage location on the file system of the client computer. The index thus maps from the chunk hash to a storage location of the chunk on the client computer. The index thus points to where a chunk exits in the client file system. Chunks for files can thus be retrieved locally from the index without retrieving them from a remote location (such as storage device 30 in FIG. 1).

In one exemplary embodiment, local chunks on the client file system are not maintained in a separate storage location as a specific chunk cache. Instead, existing chunks in the client file system are used as the chunk cache or chunk storage location. Therefore, the chunk cache (i.e., storage location of the chunks) is not independent of the file system files, but integrated or included with the file system files. Thus, the embodiment does not require additional or separate storage for the local client computer chunk cache.

In one exemplary embodiment, the chunk index is built as a side effect of storing files. For example, the index is automatically generated while back-up operations occur for the client computer. In one embodiment, a file modification date or hash verification is used to verify or ensure the portion of a file markup up a chunk has not changed since an index entry was created.

FIG. 2B illustrates an exemplary architecture for FIG. 2A in accordance with an embodiment of the present invention. By way of example, a client file system 270 stores three files A, B, and C. File A is divided into chunk 0, chunk 3, and chunk 1 with corresponding hash list hash 0, hash 3, hash 1; file B is divided into chunk 5 and chunk 7 with corresponding hash list hash 5, hash 7; and file C is divided into chunk 4, chunk 2, and chunk 6 with corresponding hash list hash 4, hash 2, hash 6. The files and corresponding entries in the hash index are stored in the client file system.

The client chunk index 280 is also stored on the client computer and is represented as a table with three columns: chunk hash, location (file containing chunk), and chunk offset in file. The chunk hash column lists the hashes for the respective files A, B, and C, and the location column indicates the file corresponding to the respective hash. For instance, as shown in the first row, the chunk corresponding to hash 0 is located in file A and has a zero offset from the beginning of the file.

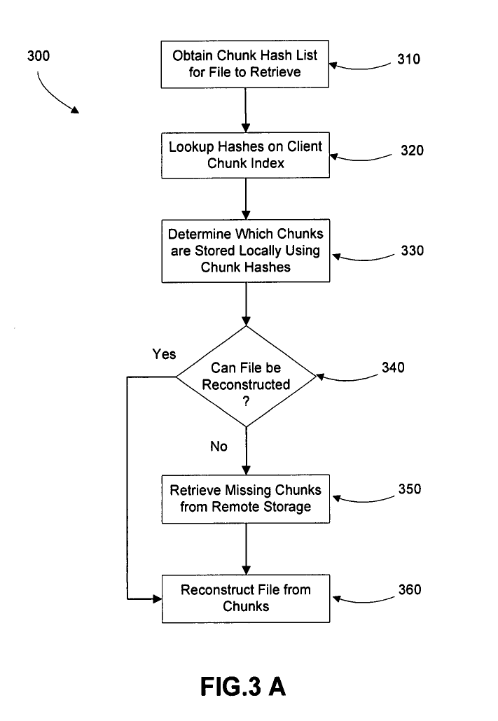

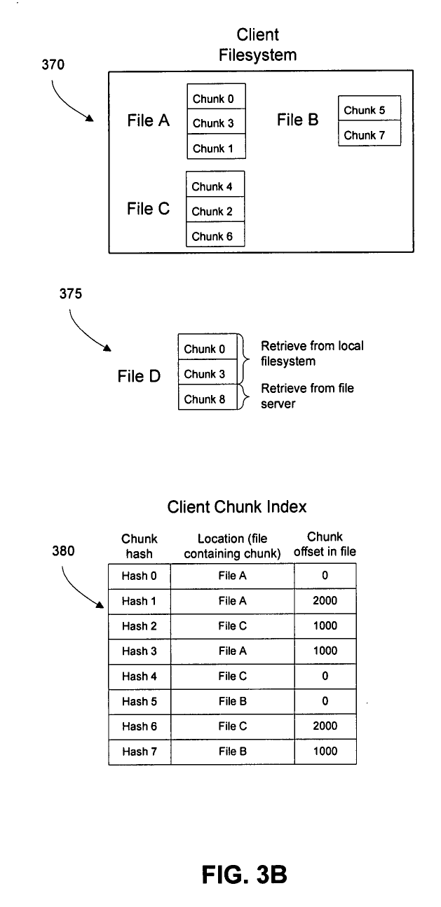

FIG. 3A illustrates an exemplary flow diagram 300 for retrieving a file in accordance with an embodiment of the present invention.

According to block 310, the chunk hash list is obtained for the file to be retrieved. The hash list includes names or lists of respective chunks for the file being retrieved.

According to block 320, the hashes for corresponding chunks to be retrieved are looked up in or obtained from the client chunk index. In other words, the list of hashes corresponding to the file is compared with the hashes included in the client chunk index.

According to block 330, a determination is made as to which chunks are stored locally in the client file system using chunk hashes and which chunks are stored remotely, example on a remote storage device.

According to block 340, a question is asked: Can the file be reconstructed from the chunks that are locally stored in the client file system?

If the answer to this question is “yes” then flow proceeds to block 360 and the file is reconstructed from the chunks locally stored in the client file system. Chunks are not retrieved from a remote location since the chunks required to reconstruct the file all exist in the client file system.

If the answer to the question is “no” then flow proceeds to block 350 wherein missing chunks are retrieved from a remote storage device. In particular, only the chunks not locally stored are retrieved from the remote storage device. For example, assume a file's hash list contains hash 0 through hash 10 and all corresponding chunks except one corresponding to hash 8 are stored in the client file system. In this example, only the chunk corresponding to hash 8 is retrieved from the remote storage.

After all chunks are retrieved (from either local and/or remote storage), the file is reconstructed. A chunked file is reconstructed by concatenating its chunks in the correct order.

FIG. 3B illustrates an exemplary architecture for FIG. 3A in accordance with an embodiment of the present invention. By way of example, the client file system 370 includes three files A, B, and C; and the client chunk index 380 provides a table containing the location within file A, B, or C of each chunk corresponding to a particular hash

File D 375 is not currently located in the client file system 370, but a user desires to retrieve or restore file D. By way of illustration, assume file D has a hash list of hash 0, hash 3, and hash 8. These three hashes (0, 3, 8) are looked up or referenced in the client chunk index 380. The index reveals that chunks associated with hash 0 and hash 3 are already locally stored. Specifically, chunk 0 and chunk 3 are already stored in the client file system in file A. Thus, it is not necessary to retrieve from remote storage chunk 0 or chunk 3. Chunk 8 is not locally stored and needs to be retrieved from a remote storage, example a remote file server. Once chunk 8 is transmitted to the client file system, file D is reconstructed using a combination of the locally and remotely stored chunks.

Exemplary embodiments utilize less bandwidth and save time. According to the example with file D, only chunk 8 is retrieved from remote storage since the remaining chunks 0 and 3 were retrieved from other files located in the client file system.

Files can also be reconstructed from chunks for plural different files. For example, assume a file F contains chunks 0, 3, 4 and 5. This file can be reconstructed for chunks 0 and 3 of file A, chunk 4 of file C, and chunk 5 of file B.

Exemplary embodiments provide for quick restoration of files utilizing minimal bandwidth to network attached storage devices. For instance, assume a user accidentally deleted file D from the client computer and the entire contents of file D were stored on a remote file server. The deleted file can be reconstructed without downloading the entire file from the remote file server. A determination is made as to whether any of the chunks for file D are already stored in the local file system using file D's hash list and the client chunk index. As shown in FIG. 3B, the client file system already includes chunks 0 and 3 for another file. Since chunk 0 and chunk 3 are locally stored for another file, these chunks are not downloaded from the file server. Only chunk 8 is downloaded from the file server. File D is then quickly reconstructed using local chunks 0 and 3 and remote chunk 8.

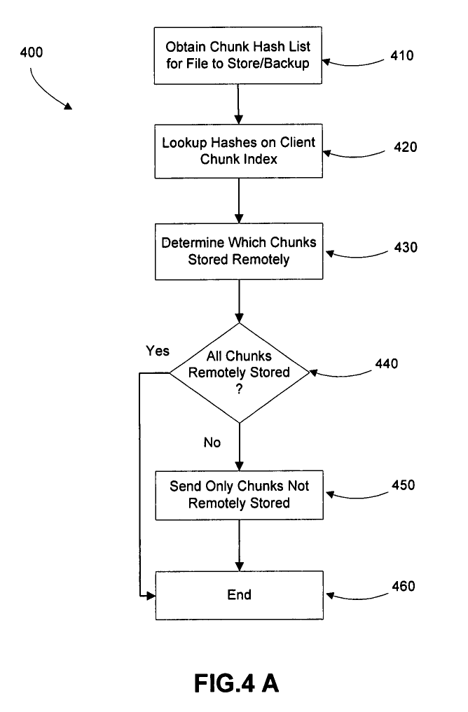

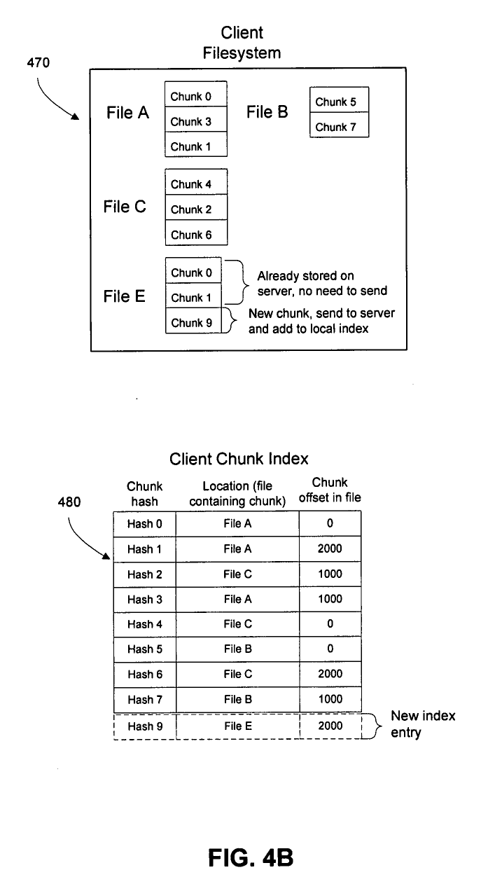

Exemplary embodiments are also used for sending files from a client computer to one or more remote storage devices. FIG. 4A illustrates an exemplary flow diagram 400 for storing a file in accordance with an embodiment of the present invention.

According to block 410, the chunk hash list is obtained for the file to be stored or backed up from a client computer to a remote storage device. The hash list includes names or lists of respective hashes for the file being stored.

According to block 420, the hashes of the chunks to be stored are looked up in or obtained from the client chunk index. In other words, the hash list corresponding to the file is compared with the hashes included in the client chunk index.

According to block 430, a determination is made as to which chunks are already stored remotely in the remote storage device.

According to block 440, a question is asked: Are all chunks remotely stored in the remote storage device?

If the answer to this question is “yes” then flow proceeds to block 460 wherein flow ends. The client chunk index is updated to indicate a location for the chunks of the file. In this instance, no chunks are transmitted to the remote storage device since the respective chunks for the file are already stored in the remote storage device.

If the answer to the question is “no” then flow proceeds to block 450 wherein only chunks not remotely stored are transmitted from the client computer to the remote storage device. For example, assume a file contains chunk 0 through chunk 10 and all chunks except chunk 8 are stored in the remote storage device. In this example, only the chunk 8 is sent to the remote storage.

FIG. 4B illustrates an exemplary architecture for FIG. 4A in accordance with an embodiment of the present invention. By way of example, the client file system 470 includes four files A, B, C, and E; and the client chunk index 480 provides a table containing the location of each chunk for each file A, B, C, and E.

By way of illustration, assume a user desires to store or backup file E to the remote storage device or remote location. File E has a chunk hash list of hash 0, hash 1, and hash 9. These three hashes (0, 1, 9) are looked up or referenced in the client chunk index 480. The index reveals that chunks associated with hash 0 and hash 1 are already remotely stored on the remote storage device. Specifically, the chunks associated with hash 0 and hash 1 are already stored in the remote storage device for file A. Thus, it is not necessary to re-send chunk 0 or chunk 1 from the client computer to the remote storage device. Chunk 9 is not remotely stored and needs to be transmitted from the client computer to the remote storage device.

While chunk 9 is being transmitted to the remote storage device, a new index entry is created in client chunk index 480. The new index entry (shown as the last row in the table) provides chunk 9 being located in file A with chunk offset of 2000.

Exemplary embodiments utilize less bandwidth and save time. According to the example with file E, only chunk 9 is transmitted to the remote storage device since the remaining chunks 0 and 1 of the file were already remotely stored in connection with one or more other, previous files.

Exemplary embodiments provide for quick storage of files to an offsite location utilizing minimal bandwidth to network attached storage devices. For instance, assume a user wants to store file E to a server located a great geographical distance from the client computer. A determination is made at the client computer as to whether any of the chunks for file E are already stored in the remote server. As shown in FIG. 4B, the client chunk index indicates that chunks 0 and 1 are already stored in the server. Since chunk 0 and chunk 1 are already remotely stored for another file, these chunks are not uploaded or transmitted from the client computer to the server. Only chunk 9 is sent to the server.

In one exemplary embodiment, different files share common chunks. For example, assume file G includes chunks 1, 2, and 3; and file H includes chunks 3, 4, and 5. A common chunk 3 exists between both files. This common chunk is not stored twice (i.e., not stored once for file G and once for file H). Instead, the common chunk is stored only once. The client chunk index is used to reference chunk 3 as being part of both file G and file H.

Exemplary embodiments provide bandwidth savings while storing to and retrieving files from a storage device. Embodiments also provide increased performance in store and restore file operations. Additional or separate storage space for chunks is not required since files are stored in the client file system in one exemplary embodiment. Further, the index is created as a side effect during storing and backing-up files. Exemplary embodiments are further utilized with fixed and/or variable length chunking.

In one exemplary embodiment, the flow diagrams are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory, and accessed by the processor using the bus. The techniques and methods for embodying software programming code in memory, on physical media, and/or distributing software code via networks are well known and will not be further discussed herein. Further, various calculations or determinations (such as those discussed in connection with the figures are displayed, for example, on a display) for viewing by a user.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method for software execution, comprising:
dividing files into segments;
calculating hash values for the segments;
creating an index that maps each of the hash values to corresponding segments within the files;
reconstructing a file by referencing the index to determine which segments of the file are stored in the file system of the client computer and which segments of the file are stored remotely on a storage device.

2) The method of claim 1, further comprising:
receiving at the client computer segments of the file stored on the storage device;
concatenating the segments of the file stored on the storage device and the segments of the file stored in the file system to reconstruct the file.

3) The method of claim 1, further comprising determining if two or more different files have a same hash value for a segment.

4) The method of claim 1, further comprising combining segments stored in the client computer with segments only stored in the storage device to reconstruct the file.

5) The method of claim 1, further comprising storing each of the segments only once in the storage device even when two or more different files have a same segment.

6) The method of claim 1, further comprising:
retrieving a first portion of segments required to reconstruct the file from the storage device and a second portion of segments required to reconstruct the file from the client computer;
combining the first and second portions to reconstruct the file.

7) A computer readable medium having instructions for causing a computer to execute a method, comprising:
dividing a file into hashed chunks;
storing a first portion of the hashed chunks in a file system of a client computer and a second portion of the hashed chunks in a remote storage device;
requesting only the second portion of the hashed chunks from the remote storage device to reconstruct the file at the client computer.

8) The computer readable medium of claim 7 further comprising:
creating an index that maps each of the hashed chunks to their location in the file;
storing the index on the client computer.

9) The computer readable medium of claim 7 further comprising, determining if any of the first portion of the hashed chunks is stored in the remote storage device before transmitting any of the first portion of the hashed chunks to the remote storage device.

10) The computer readable medium of claim 7, further comprising generating a table having an ordered list of the hashed chunks that when linked together form the file.

11) The computer readable medium of claim 7, further comprising comparing hashed chunks from a second file with the hashed chunks from the file to determine if duplicative hashed chunks exist between the file and the second file.

12) The computer readable medium of claim 7, further comprising dividing the hashed chunks into a first group that is stored on the client computer and a second group that is transmitted to the remote storage device.

13) The computer readable medium of claim 7, further comprising reducing bandwidth usage between the client computer and remote storage device by requesting only the second portion of the hashed chunks from the remote storage device to reconstruct the file at the client computer.

14) A computer, comprising:
memory for storing an algorithm; and
processor for executing the algorithm to:
divide a first file into first chunks and a second file into second chunks;
link at least one of the first chunks with at least one of the second chunks to reconstruct a third file.

15) The computer of claim 14, wherein the processor further executes the algorithm to compare hash values of the first chunks with hash values of the second chunks to determine common hash values between the first and second chunks.

16) The computer of claim 14, wherein the processor further executes the algorithm to create a table that maps the first chunks to the first file and the second chunks to the second file.

17) The computer of claim 14, wherein only a single copy of a chunk occurring in both the first and second files is stored in the computer.

18) The computer of claim 14, wherein the first and second chunks are stored in a file system of a client computer.

19) The computer of claim 14, wherein the processor further executes the algorithm to compare the first chunks with the second chunks to determine if the first and second files have chunks in common.

20) The computer of claim 14, wherein the processor further executes the algorithm to reconstruct the first file from a first portion of the first chunks that are stored in a client computer and a second portion of the first chunks that are stored in a remote storage device.
